(19) United States
(12) Patent Application Publication
(10) Pub. No.: US 2019/0193103 A1
(43) Pub. Date: Jun. 27, 2019

(54) COATING DEVICE AND COATING METHOD

(71) Applicant: TORAY ENGINEERING CO., LTD., Tokyo (JP)

(72) Inventor: Satoshi TOMOEDA, Otsu-shi (JP)

(21) Appl. No.: 16/232,161

(22) Filed: Dec. 26, 2018

(30) Foreign Application Priority Data
Dec. 25, 2017 (JP) 2017-247376

(51) Int. Cl. B05C 5/02; B05D 1/26

(52) U.S. Cl. CPC B05C 5/02; B05D 1/26

(57) ABSTRACT

A coating device includes a nozzle, a pressure wave imparting component, and a controller. For each discharge of the coating liquid, the controller causes the pressure wave imparting component to perform a shaking operation that generates a pressure wave in the coating liquid inside the nozzle to an extent that a droplet is not discharged from the nozzle and the coating liquid is shaken in the nozzle, and a discharge operation that generates a pressure wave in the coating liquid inside the nozzle to an extent that a droplet is discharged from the nozzle after the shaking operation. The drive of the pressure wave imparting component in the shaking operation and the drive of the pressure wave imparting component in the discharge operation are kept constant, and a waiting time between the shaking operation and the discharge operation is adjusted.

### CROSS-REFERENCE TO RELATED APPLICATIONS

This application claims priority to Japanese Patent Application No. 2017-247376 filed on Dec. 25, 2017. The entire disclosure of Japanese Patent Application No. 2017-247376 is hereby incorporated herein by reference.

### BACKGROUND

### Field of the Invention

This invention generally relates to a coating device and a coating method. More specifically, the present invention relates to a coating device and a coating method with which a substrate is coated with a coating liquid to form a coating pattern.

### Background Information

In forming a coating pattern of the desired shape on a substrate, in recent years it has been customary to employ a coating using an inkjet method (see Japanese Patent Application Publication 2005-109390 (Patent Literature 1), for example), rather than a coating using the photolithography. Whereas the photolithography entails numerous processes such as coating, exposure, and etching, and a large quantity of coating material is consumed in the etching process, with an inkjet method, a coating pattern can be formed in fewer processes and without wasting that much coating material.

### SUMMARY

Here, if it is necessary to adjust the coating amount of the coating liquid at a specific position on a substrate, examples of a way to accomplish this are a method in which the number of droplets discharged from the inkjet head to the predetermined position is adjusted, and a method in which the size (discharge amount) of the droplet discharged in a single discharge operation from the inkjet head is adjusted.

Especially when adjusting the discharge amount of the droplet discharged in a single discharge operation from an inkjet head, it is possible to adjust the discharge amount by adjusting the voltage applied to the piezoelectric actuator that performs the discharge operation. In this case, a discharge control pattern in accordance with a comparative example can be used which features a series of drive waveforms of different applied voltages as shown in FIG. 6 (the drive waveforms 1 to 4 in FIG. 6, for example), and the discharge amount can be controlled depending on which the drive waveform is selected at each discharge position. That is, as shown in FIG. 7A, when the drive waveform 1 is selected at a given discharge position, the droplet with a discharge amount m1 corresponding to the drive waveform 1 can be discharged, and as shown in FIG. 7B, at the other discharge position, the drive waveform 3 is selected so that the droplet with a discharge amount m3 can be discharged.

However, when discharge amount control such as this is performed, it is necessary to leave enough time for the series of the drive waveforms of the plurality of patterns for a single discharge. Thus, discharge takes much longer than when it is performed with a drive waveform of just one pattern. In particular, when discharge is performed continuously while moving the inkjet head relative to the substrate, the movement time between adjacent discharge positions must be at least equal to the duration of this series of patterns. Therefore, a problem is that the moving speed of the inkjet is limited and the coating speed is lowered.

The present invention is conceived in light of the above problem. It is an object thereof to provide a coating device and a coating method with which the discharge amount can be adjusted for each discharge, and the coating liquid can be discharged at high speed.

In view of the state of the known technology, a coating device is provided for coating a substrate with a coating liquid to form a coating pattern. The coating device includes a nozzle, a pressure wave imparting component and a controller. The nozzle is configured to discharge droplets of the coating liquid. The pressure wave imparting component is configured to generate a pressure wave in the coating liquid inside the nozzle. The controller is configured to control a drive of the pressure wave imparting component. For each discharge of the coating liquid, the controller is configured to cause the pressure wave imparting component to perform a shaking operation and a discharge operation. The shaking operation is configured to generate a pressure wave in the coating liquid inside the nozzle to an extent that a droplet is not discharged from the nozzle and the coating liquid is shaken in the nozzle. The discharge operation is configured to generate a pressure wave in the coating liquid inside the nozzle to an extent that a droplet is discharged from the nozzle after the shaking operation. The drive of the pressure wave imparting component in the shaking operation and the drive of the pressure wave imparting component in the discharge operation are kept constant, and a waiting time between the shaking operation and the discharge operation is adjusted.

With this coating device, the discharge amount can be adjusted at each discharge, and it is possible to discharge the coating liquid at a high speed, for example. More specifically, performing the discharge operation in a state in which the pressure wave due to the shaking operation remains after the shaking operation greatly affects the size of the pressure wave generated in the discharge operation, for example. Since the pressure inside the nozzle at the start of the discharge operation varies when the waiting time is adjusted, the pressure wave generated by the discharge operation also varies, and the discharge amount of the droplet discharged from the nozzle can be varied.

The pressure wave imparting component can include a piezoelectric actuator, and is configured to generate a pressure wave in the coating liquid inside the nozzle by applying voltage to the piezoelectric actuator to change the volume within the nozzle.

With this coating device, a configuration that generates a pressure wave in the coating liquid inside the nozzle can be easily formed.

In view of the state of the known technology, a coating method is provided for forming a coating pattern on a substrate by discharging droplets of coating liquid from a nozzle. The coating method includes performing a shaking operation for generating a pressure wave in the coating liquid inside the nozzle to an extent that a droplet is not be discharged from the nozzle and the coating liquid inside the nozzle is shaken, and performing a discharge operation for generating a pressure wave in the coating liquid inside the nozzle to an extent that a droplet is discharged from the nozzle after the performing of the shaking operation. The performing of the shaking operation and the performing of the discharge operation are performed for each discharge of the coating liquid. The shaking operation and the discharge operation are kept constant, and a waiting time between the shaking operation and the discharge operation is adjusted.

With this coating method, the discharge amount can be adjusted at each discharge, and it is possible to discharge the coating liquid at high speed, for example. More specifically, after the shaking operation, the discharge operation is performed in a state in which the pressure wave resulting from the shaking operation still remains, and this affects the size of the pressure wave generated in the discharge operation. Since the pressure inside the nozzle changes at the start of the discharge operation when the waiting time is adjusted, the pressure wave generated in the discharge operation also changes, and the discharge amount of the droplet discharged from the nozzle can be varied.

With the coating device and the coating method, the discharge amount can be adjusted at each discharge, and it is possible to discharge the coating liquid at high speed.

### BRIEF DESCRIPTION OF THE DRAWINGS

Referring now to the attached drawings which form a part of this original disclosure:

FIG. 1 is a schematic diagram of a coating device in accordance with one embodiment;

FIG. 2 illustrates a process in which a droplet is discharged from a nozzle of the coating device illustrated in FIG. 1, part (A) of FIG. 2 being a graph of a transition in voltage applied to a drive partition wall of the nozzle, part (B) of FIG. 2 being a schematic diagram of a change in the shape of the drive partition wall due to the transition in the applied voltage in the part (A) of FIG. 2;

FIG. 3 is a graph of a waveform of the voltage applied to the drive partition wall of the nozzle;

FIG. 4 is a graph of the waveform of the voltage applied to the drive partition wall of the nozzle and the change in pressure of the coating liquid inside the nozzle;

FIGS. 5A and 5B illustrate a method for adjusting the discharge amount of the droplet, FIG. 5A illustrating a case in which a relatively short waiting time is set between a shaking operation and a discharge operation, FIG. 5B illustrating a case in which a relatively long waiting time is set between the shaking operation and the discharge operation;

FIG. 6 is a graph of a waveform of voltage applied to discharge a droplet in a comparative example; and

FIGS. 7A and 7B illustrates a method for adjusting the discharge amount of the droplet in the comparative example.

### DETAILED DESCRIPTION OF EMBODIMENTS

Selected embodiments will now be described through reference to the drawings. It will be apparent to those skilled in the art from this disclosure that the following descriptions of the embodiments are provided for illustration only and not for the purpose of limiting the invention as defined by the appended claims and their equivalents.

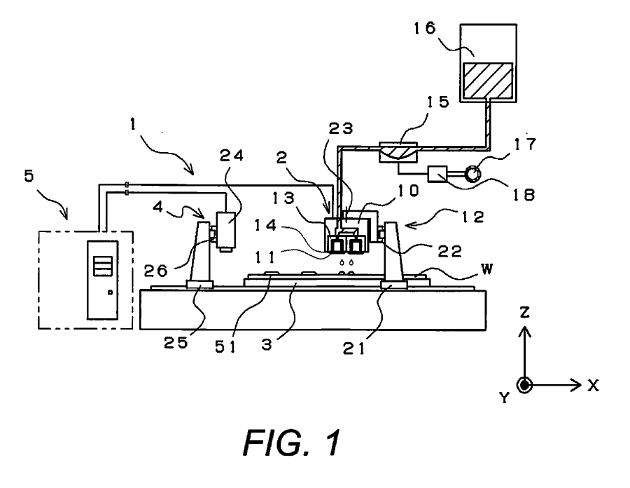

FIG. 1 is a schematic diagram of a coating pattern forming device or coating device 1 in accordance with one embodiment. The coating device 1 is a device with which a substrate W is coated with a coating liquid by inkjet method to form a coating film in a desired pattern or coating pattern 51. The coating device 1 comprises a coating component or coater 2, a coating stage 3, a lyophilicity adjuster 4, and an electronic controller 5. The coating component 2 moves above a substrate W on the coating stage 3 while droplets of the coating liquid are discharged from nozzles 11 inside the coating component 2, thereby coating the substrate W. The droplets that land on the substrate W link up with each other, forming the coating pattern 51 on the substrate W. Also, before the coating component 2 discharges the droplets at the substrate W, the lyophilicity adjuster 4 adjusts the lyophilicity of the pattern area, which is an area on the substrate W in which the coating pattern 51 is formed, and controls in advance how the coating liquid spreads out after formation of the coating pattern 51.

In the following description, the direction in which the coating component 2 moves (scans) during the discharge of the droplets at the substrate W shall be referred to as the X axis direction, the direction perpendicular to the X axis direction and the horizontal plane as the Y axis direction, and the direction perpendicular to both the X axis and the Y axis directions as the Z axis direction.

The coating component 2 has a coating head 10 and a coating head moving device 12. The coating head 10 can be moved to any position of the substrate W on the coating stage 3 by the coating head moving device 12, and in the course of the continuous movement of the coating head 10, the coating head 10 discharges the droplets by inkjet method from the nozzles 11 at the discharge target every time a pre-programmed discharge position is reached.

The coating head 10 has a substantially cuboid shape whose lengthwise direction is the Y axis direction, and a plurality of discharge units 13 are incorporated therein.

The discharge units 13 are provided with a plurality of the nozzles 11. The discharge units 13 are incorporated into the coating head 10 so that the nozzles 11 are arranged on the lower face of the coating head 10.

Also, the coating head 10 communicates with a sub-tank 15 via tubing. The sub-tank 15 is provided near the coating head 10, and its job is to temporarily store the coating liquid supplied through tubing from a main tank 16 provided away from the sub-tank 15, and to supply the coating liquid to the coating head 10 with a high accuracy. The coating liquid supplied from the sub-tank 15 to the coating head 10 branches within the coating head 10, and is supplied to all the nozzles 11 of each discharge unit 13.

Each of the nozzles 11 has a drive partition wall 14. The controller 5 performs on/off control of discharge of each of the nozzles 11, thereby deforming the drive partition wall 14 of a given nozzle 11 and discharging the droplets. In this embodiment, a piezoelectric actuator is used as the drive partition wall 14. When voltage is applied to the drive partition wall 14, this produces deformation of the drive partition wall 14. In particular, the controller 5 performs the on/off control or discharge control of the nozzles 11 by applying the voltage to the drive partition walls 14 of the nozzles 11 via a driver.

Also, in order to stabilize the discharge of the droplets from the nozzles 11, it is necessary for the coating liquid to maintain an interface (meniscus) of a specific shape in each nozzle 11 while waiting for the next discharge. Therefore, a specific amount of negative pressure is imparted inside the sub-tank 15 by a vacuum source 17. This negative pressure is regulated by a vacuum pressure regulating valve 18 provided between the sub-tank 15 and the vacuum source 17.

The coating head moving device 12 has a scanning direction moving device 21, a shift direction moving device 22, and a rotating device 23. The coating head moving device 12 moves the coating head 10 in the X axis direction and the Y axis direction, and rotates it in the Z axis direction (the rotational axis).

The scanning direction moving device 21 is a linear movement mechanism made up of a linear stage or the like, and moves the coating head 10 in the X axis direction (the scanning direction), and its drive is controlled by the controller 5.

The scanning direction moving device 21 is driven to discharge the droplets from the nozzles 11 while scanning with the coating head 10 above the substrate W, so that coating areas aligned in the X axis direction are continuously coated with the coating liquid.

The shift direction moving device 22 is a linear movement mechanism made up of a linear stage or the like, and moves the coating head 10 in the Y axis direction (the shift direction), and its drive is controlled by the controller 5.

Consequently, when the discharge units 13 are disposed spaced apart inside the coating head 10, coating is performed while scanning the coating head 10 in the X axis direction, after which the coating head 10 is shifted in the Y axis direction and coating is again performed so as to fill in the spaces, which makes it possible to coat the entire surface of the substrate W.

Also, even if the width of the substrate W in the Y axis direction is greater than the length of the coating head 10, the coating head 10 can be shifted in the Y axis direction every time one coating operation is completed. By dividing up the coating into a plurality of passes, it is possible to coat the entire surface of the substrate W.

The rotating device 23 is a rotation stage in which the rotation axis is the Z axis direction, and its drive is controlled by the controller 5 to rotate the coating head 10.

Adjusting the angle of the coating head 10 with this rotating device 23 adjusts the spacing of the nozzles 11 in the direction (Y axis direction) perpendicular to the scanning direction of the coating head 10, so that the spacing will be suitable for the size of the coating area and the size of the droplets.

The coating stage 3 has a mechanism for fixing the substrate W. The operation of coating the substrate W is performed in a state in which the substrate W has been placed on and fixed to the coating stage 3. In this embodiment, the coating stage 3 has a suction mechanism, and a vacuum pump or the like (not shown) is actuated to generate a suction force at the surface that contacts with the substrate W and to fix the substrate W by this suction.

Also, the coating stage 3 can be moved in the X axis direction and the Y axis direction by a drive device (not shown), and can be rotated in the Z axis direction (the rotation axis). After an alignment device (not shown) checks an alignment mark on the substrate W placed on the coating stage 3, the coating stage 3 moves or rotates in the correction of any offset in the placement of the substrate W on the basis of the result of this check. Since the movement and rotation of the coating stage 3 are for the purpose of fine adjustment of the placement state of the substrate W, the movable distance of the coating stage 3 and the rotatable angle of the coating stage 3 can be very small.

The substrate on the coating stage 3 can be moved to directly below the lyophilicity adjuster 4. After the lyophilicity of the substrate W has been adjusted by the lyophilicity adjuster 4 directly below the lyophilicity adjuster 4, the substrate W moves to directly below the coating component 2, and then a coating pattern is formed by the coating component 2.

In this embodiment, the lyophilicity adjuster 4 is an exposure device 24, which irradiates the substrate W with ultraviolet rays.

Here, the substrate W of the present disclosure is, for example, a glass substrate, a silicon wafer, a resin film, or the like, and its surface is modified by irradiation with ultraviolet rays to change its lyophilicity. Since the degree of lyophilicity of the surface of the substrate W varies with the length of irradiation with ultraviolet rays, in this embodiment the duration of ultraviolet irradiation from the lyophilicity adjuster 4 at each position of the substrate W is controlled by the controller 5, and the degree of lyophilicity at each position of the substrate W is adjusted.

Also, even at a given irradiation duration, the degree of lyophilicity can be adjusted by means of the wavelength or intensity of the ultraviolet rays. Therefore, the lyophilicity adjuster 4 can be designed such that the wavelength or intensity of the ultraviolet rays in ultraviolet irradiation at each position of the substrate W is controlled by the controller 5 to adjust the degree of lyophilicity at each position of the substrate W. Also, a plurality of the lyophilicity adjusters 4 that emit ultraviolet rays of different wavelengths or intensities can be provided. In this case, these lyophilicity adjusters 4 can be selectively used under the control of the controller 5 to adjust the lyophilicity at each position of the substrate W.

Also, the lyophilicity adjuster 4 can be incorporated into the scanning direction moving device 25 and the shift direction moving device 26. The lyophilicity adjuster 4 can be moved in the X axis direction and the Y axis direction by driving these moving devices.

The scanning direction moving device 25 is a linear movement mechanism made up of a linear stage or the like, and its drive is controlled by the controller 5 to move the lyophilicity adjuster 4 and the shift direction moving device 26 in the X axis direction.

The shift direction moving device 26 is a linear motion mechanism made up of a linear stage or the like, and its drive is controlled by the controller 5 to move the lyophilicity adjuster 4 in the Y axis direction.

Here, the drive of the scanning direction moving device 25 and the shift direction moving device 26 is controlled by the controller 5 so that the lyophilicity adjuster 4 moves relatively in the X axis direction and the Y axis direction with respect to the substrate W placed on the coating stage 3, and the lyophilicity at a given position on the substrate W is changed.

The controller 5 has a computer, a sequencer, a processor, etc. The controller 5 controls the supply of liquid to the coating head 10, the adjustment of discharge and the discharge amount of the droplet from the nozzles 11 by driving the drive partition walls 14 of the nozzles 11, the operation of the lyophilicity adjuster 4, and so forth.

Also, the controller 5 has a storage device that stores various kinds of information and consists of a hard disk, a RAM, a ROM, or another such memory. Coating data such as coordinate data for the discharge positions of the droplets for forming the coating film in the pattern area is stored in this storage device. Data about the voltage waveform to be applied for driving the drive partition walls 14 or the like is also stored in this storage device.

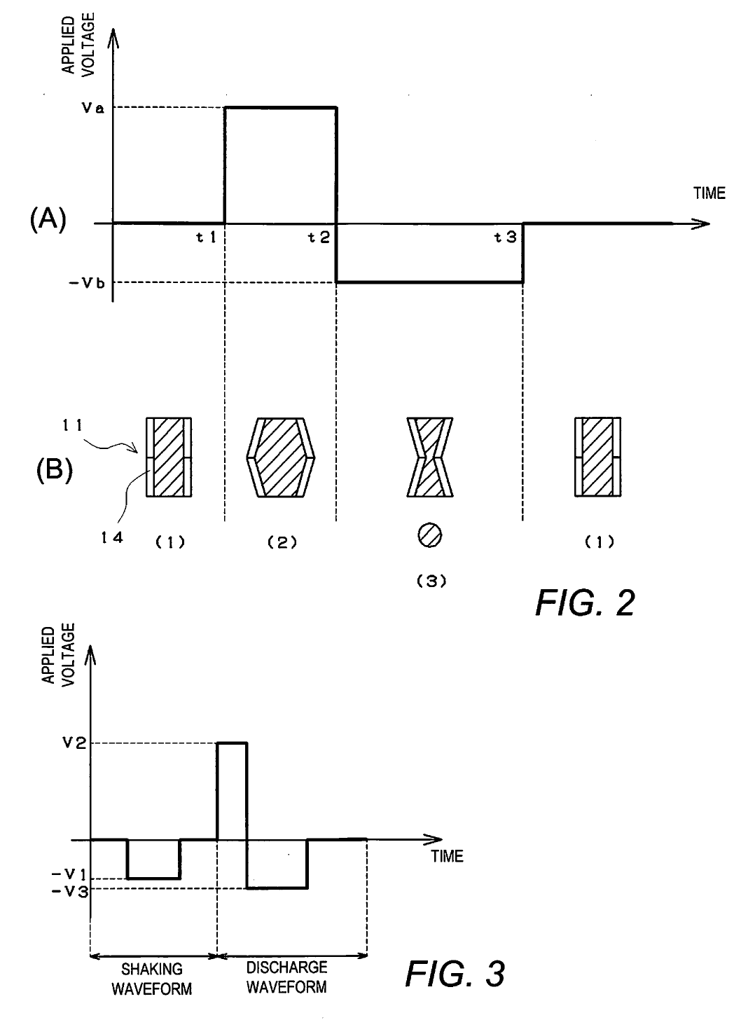

Next, FIG. 2 shows a process (discharging process) in which a droplet is discharged from each nozzle 11 by the operation of the individual drive partition wall 14 of the nozzle 11. Part (A) of FIG. 2 is a graph of the transition in the voltage applied to the drive partition wall 14 of the nozzle 11, and part (B) of FIG. 2 is a schematic diagram of the change in the shape of the drive partition wall 14 due to the transition in the applied voltage in the part (A) of FIG. 2. In the illustrated embodiment, the discharging process for one of the nozzles 11 will only be explained for the sake of brevity. However, of course, the discharging process can be similarly applied to other nozzles 11. Also, the discharging process can be independently applied to the nozzles 11.

No voltage is applied to the drive partition wall 14 until the time t1, and the drive partition wall 14 is in an original state (the state (1)).

When a positive voltage (Va) is applied between times t1 and t2, the drive partition wall 14 on both sides of the nozzle 11 is deformed (the state (2)), the volume of the nozzle 11 increases, and coating liquid is pulled into the nozzle 11 from the main tank 16.

Between the times t2 and t3, on the other hand, a negative voltage (−Vb) is applied, the drive partition wall 14 on both sides of the nozzle 11 is deformed in the direction of constricting (the state (3)), and the volume of the nozzle 11 decreases. At this point, the coating liquid that has been drawn in the nozzle 11 in the state (2) overcomes the negative pressure produced by the vacuum source 17 and is pushed out to the outside of the nozzle 11. This becomes the discharge of the droplet.

From the time t3 onward, voltage is not applied, and the drive partition wall 14 of the nozzle 11 returns to the original state (the state (1)). Performing this series of operations at the proper timing results in the droplets being discharged from the nozzle 11 at the desired timing. Also, the waveform of the change in the applied voltage for discharging the droplet in this manner is referred to as a discharge waveform in this description.

Next, an example of the waveform of the voltage applied to the drive partition wall 14 of the nozzle 11 in this embodiment is shown in FIG. 3.

In this embodiment, a shaking waveform is applied to the drive partition wall 14 of the nozzle 11 before applying the discharge waveform. The shaking waveform is a waveform only for reducing the volume of the nozzle 11 by applying a voltage (−V1) for a specific length of time and then for driving the drive partition wall 14 so as to return to the original state. The discharge waveform is a waveform for discharging the droplet from the nozzle 11 by driving the drive partition wall 14 such that a voltage V2 is applied to increase the volume of the nozzle 11, after which a voltage (−V3) is applied to reduce the volume of the nozzle 11. Applying this shaking waveform does not discharge the coating liquid inside the nozzle 11 from the nozzle 11, but shakes it inside the nozzle 11. In the illustrated embodiment, as shown in FIG. 3, the shaking waveform has a pulse with the voltage (−V1) (e.g., the predetermined voltage) for the specific length of time. Also, the discharge waveform has a first pulse with the voltage V2 (e.g., the first predetermined voltage) and a second pulse with the voltage (−V3) (e.g., the second predetermined voltage). The voltage V2 (e.g., the first predetermined voltage) of the discharge waveform has an opposite polarity to the voltage (−V3) of the discharge waveform. Furthermore, the controller 5 causes the drive partition wall 14 (e.g., the pressure wave imparting component) to increase the volume of the nozzle 11 at a timing of the first pulse (see the state (2) in FIG. 2) and to reduce the volume of the nozzle 11 at a timing of the second pulse (see the state (3) in FIG. 2).

A method in which the coating liquid inside the nozzle 11 is shaken when no droplets are discharged from the nozzle 11 is generally used to suppress an increase in the viscosity of the coating liquid inside the nozzle 11 while no coating liquid is discharged.

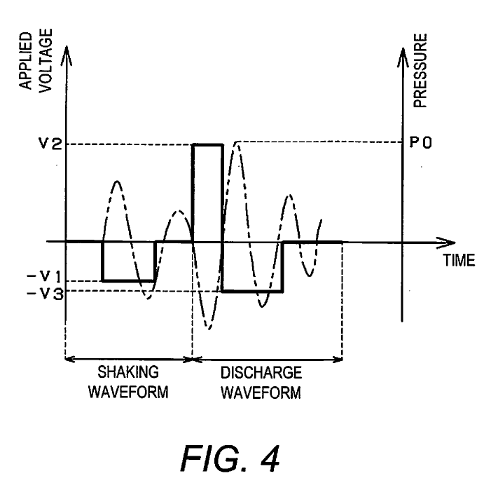

FIG. 4 shows the pressure change in the coating liquid inside the nozzle 11 that is superposed over the shaking waveform and the discharge waveform. The two-dot chain line in FIG. 4 shows the pressure change (i.e., a relative pressure value) in the coating liquid inside the nozzle 11 using a pressure value in a state in which no voltage is applied to the drive partition wall 14 and the coating liquid inside the nozzle 11 is stationary as a reference (i.e., zero).

As shown in FIG. 4, at the points when the shaking waveform is applied and when the discharge waveform is applied, as the volume of the nozzle 11 changes, the pressure of the coating liquid in the nozzle 11 changes in a wave shape. In the example in FIG. 4, the pressure inside the nozzle 11 reaches P0, which is the maximum value, at the point when the volume inside the nozzle 11 has decreased due to the application of the voltage (−V3) after the volume in the nozzle 11 has first risen at the point of application of the discharge waveform. At this point, the droplet is discharged from the nozzle 11 in a discharge amount corresponding to the pressure P0. In this description, such a wave of change in the pressure of the coating liquid in the nozzle 11 is called a pressure wave. Also, the member that generates the pressure wave in the coating liquid in the nozzle 11 (in this description, the drive partition wall 14 which includes piezoelectric actuators) is called a pressure wave imparting component.

Also, in this description, for example, an operation in the coating device 1 in which the controller 5 applies the shaking waveform to the drive partition wall 14 (e.g., the pressure imparting component) so that the pressure wave of such a degree that no droplets will be discharged from the nozzle 11 is generated in the coating liquid inside the nozzle 11 is called a shaking operation. Also, an operation in which the controller 5 applies the discharge waveform to the drive partition wall 14 so that the pressure wave of such a degree that the droplet of the coating liquid will be discharged from the nozzle 11 is generated in the coating liquid inside the nozzle 11 is called a discharge operation. In the present disclosure, this shaking operation and discharge operation are continuously performed each time the droplet is discharged from the nozzle 11.

In the series of coating methods performed by the coating device 1, a step of shaking the coating liquid inside the nozzle 11 by generating the pressure wave in the coating liquid inside the nozzle 11 to such an extent that no droplets will be discharged from the nozzle 11 is called a shaking step. Also, a step of generating the pressure wave in the coating liquid inside the nozzle 11 to such an extent that the droplet will be discharged from the nozzle 11 is called a discharge step.

Whereas droplets will not be discharged from the nozzle 11 by the shaking operation and the shaking step alone, the droplet will be discharged from the nozzle 11 by the discharge operation and the discharge step alone. This means that the pressure wave produced by the discharge operation and the discharge step alone is larger than the pressure wave produced by the shaking operation and the shaking step alone.

With the present disclosure, even when discharge is performed a plurality of times on the substrate W, the operation of generating the pressure wave in the shaking operation (shaking step) and the operation of generating the pressure wave in the discharge operation (discharge step) are each kept constant. That is, in this embodiment, each time the droplet is discharged, the controller 5 constantly applies to the drive partition wall 14 the same shaking waveform that applies the voltage (−V1) for the specific length of time in the shaking operation and the shaking step, and the controller 5 constantly applies to the drive partition wall 14 the same discharge waveform that applies the voltage V2 for a specific length of time and then the voltage (−V3) for a specific length of time in the discharge operation and the discharge step. In the illustrated embodiment, the controller 5 controls the drive of the drive partition wall 14 (e.g., the pressure wave imparting component) according to the shaking waveform during the shaking operation and according to the discharge waveform during the discharge operation, with the shaking waveform being different from the discharge waveform. Also, the controller 5 causes the drive partition wall 14 to reduce the volume of the nozzle 11 for the specific length of time according to the shaking waveform during the shaking operation. Furthermore, the controller 5 causes the drive partition wall 14 to increase the volume of the nozzle 11 before reducing the volume of the nozzle 11 according to the discharge waveform during the discharge operation. Also, the drive of the drive partition wall 14 in the shaking operation and the drive of the drive partition wall 14 in the discharge operation are kept constant for a plurality of discharges of the coating liquid.

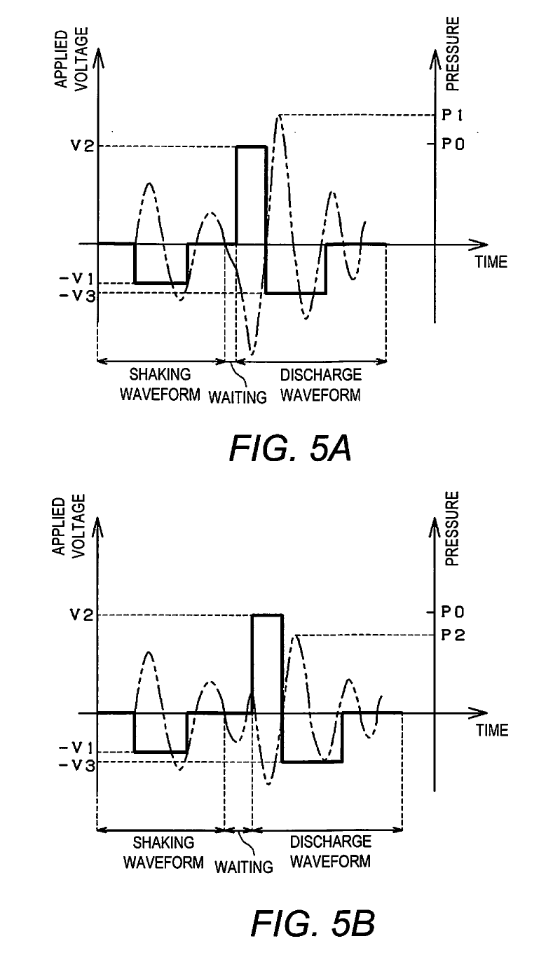

Furthermore, in the present disclosure, the discharge amount is adjusted by adjusting a waiting time, which is a time between the shaking operation (shaking step) and the discharge operation (discharge step). This process is shown in FIGS. 5A and 5B.

As shown in FIG. 5A, when the shaking waveform is applied in the shaking operation, the pressure of the coating liquid inside the nozzle 11 is not stabilized immediately after completion of the shaking operation, and instead pressure of the coating liquid inside the nozzle 11 keeps fluctuating up and down for a short time even after the shaking operation. That is, the pressure wave continues. In the present disclosure, the time from immediately after the completion of the shaking operation until when the pressure wave of the coating liquid inside the nozzle 11 attributable to the shaking operation settles down is set as the upper limit of the waiting time. The waiting time of a desired length is set within that range. The discharge operation is started immediately after this waiting time has elapsed.

FIG. 4 shows a case when the waiting time is zero in this embodiment. In this embodiment, although the pressure wave continues, the timing that the above-mentioned relative pressure value hits zero is considered to be the timing when the shaking operation is complete, that is, the timing when the waiting time begins.

FIG. 5A shows a case in which a relatively short waiting time is set. The relative pressure value of the coating liquid inside the nozzle 11 at the start of the discharge operation becomes negative after the length of the waiting time has elapsed after the completion of the shaking operation. When the discharge operation is started from this state, the amplitude of the pressure wave that is produced by the discharge operation and the relative pressure value of which firstly shifts to decrease (FIG. 5A) is larger than the amplitude of the pressure wave when the discharge operation starts in a state in which the relative pressure value is zero (FIG. 4). In particular, the pressure reached when the voltage (−V3) is applied is P1, which is larger than P0 in FIG. 4. Thus, the discharge amount of the droplet discharged from the nozzle 11 at this point is larger than when the waiting time is zero, as shown in FIG. 4.

FIG. 5B shows a case in which a relatively long waiting time is set. In this case, the relative pressure value of the coating liquid inside the nozzle 11 at the start of the discharge operation is positive. When the discharge operation is started from this state, the amplitude of the pressure wave that is produced by the discharge operation and the relative pressure value of which firstly shifts to decrease (FIG. 5B) is smaller than the amplitude of the pressure wave when the discharge operation starts in a state in which the relative pressure value is zero (FIG. 4). In particular, the pressure reached when the voltage (−V3) is applied is P2, which is smaller than P0 in FIG. 4. Thus, the discharge amount of the droplet discharged from the nozzle 11 at this point is smaller than when the waiting time is zero, as shown in FIG. 4. Thus, in the illustrated the waiting time between the shaking operation and the discharge operation is adjusted according to the discharge amount of the droplet of the coating liquid. Furthermore, the waiting time between the shaking operation and the discharge operation is adjusted for each discharge of the droplet of the coating liquid.

Thus, it is possible to adjust the discharge amount of the droplet discharged from the nozzle 11 by adjusting the waiting time, and thus it is possible to discharge the droplets in various discharge amounts onto a single substrate W.

In this embodiment, gradation data for identifying the color density of the film formed by coating with the coating liquid is stored in the coating data stored in the storage device of the controller 5. Furthermore, as well as this gradation data, several bits of data are used as data for the waiting time in each discharge. More specifically, three bits of data are used as data for the waiting time. In particular, the waiting time can be set as desired for each discharge in eight patterns. For example, if the value of this data is “000,” then the waiting time is set to 0 usec (usec) (no waiting time), if it is “001,” 0.5 usec, if it is “010,” 1.0 usec, . . . and if it is “111,” 3.5 usec. That is, these eight patterns of the discharge amount can be set as desired for each discharge.

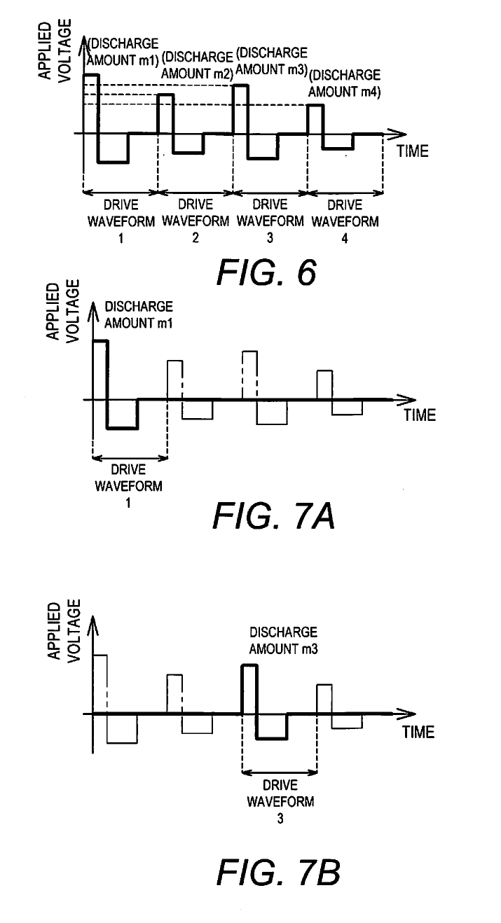

On the other hand, when the droplet is discharged in a discharge amount of about 10 pL, for example, the shaking operation will take about 15 usec, and the discharge operation will take about 40 usec. With the coating method shown in FIG. 6 in accordance with the comparative example, for providing eight patterns of the discharge amount as described above, the movement time between adjacent discharge points that is at its shortest equal to (duration of discharge operation)×(The number of patterns of discharge amount), or in other words, 40 usec×8=320 usec is required. On the other hand, with the coating device 1 in the present disclosure, the minimum required movement time is 15 usec+3.5 usec+40 usec=58.5 usec. This movement time is much shorter than that of the coating method in accordance with the comparative example. That is, coating can be performed at higher speed.

With the coating device 1 and the coating method described above, the discharge amount can be adjusted for each discharge, and it is possible to discharge the coating liquid at high speed.

Here, the coating device and the coating method of the present disclosure are not limited to the embodiments given above, and other modes also fall within the scope of the present invention. For instance, in the above description, the drive partition wall 14 that includes a piezoelectric actuator is an example of the pressure wave imparting means or component. However, the pressure wave imparting means or component can be a configuration other than using a piezoelectric actuator, so long as the pressure wave is generated in the coating liquid inside the nozzle. For example, in a configuration in which a droplet is discharged from a nozzle by applying thermal energy to a coating liquid, a pressure wave corresponding to a shaking operation and a discharge operation can be generated in the coating liquid inside the nozzle by controlling the thermal energy to be applied.

Also, the timing that the shaking operation is completed, that is, the timing that the waiting time starts, is not necessarily the timing that the above-mentioned relative pressure value hits zero. Instead of the timing that the relative pressure value becomes zero, a timing that is common among the discharges can be considered as the timing that the waiting time starts. In this case, the discharge amount of the droplet can be adjusted in a above-described manner by adjusting the waiting time from that timing.

In view of the state of the known technology, a coating device is provided for coating a substrate with a coating liquid to form a coating pattern. The coating device includes a nozzle, a pressure wave imparting component and a controller. The nozzle discharges droplets of the coating liquid. The pressure wave imparting component generates a pressure wave in the coating liquid inside the nozzle. The controller controls the drive of the pressure wave imparting component. Every time the coating liquid is discharged, the controller causes the pressure wave imparting component to perform a shaking operation and a discharge operation. The shaking operation generates a pressure wave in the coating liquid inside the nozzle to the extent that a droplet will not be discharged from the nozzle to shake the coating liquid in the nozzle. The discharge operation generates a pressure wave in the coating liquid inside the nozzle to the extent that a droplet will be discharged from the nozzle after the shaking operation. The drive of the pressure wave imparting component in the shaking operation and the drive of the pressure wave imparting component in the discharge operation are each kept constant, and the waiting time, which is the time between the shaking operation and the discharge operation, is adjusted.

With this coating device, the discharge amount can be adjusted at each discharge, and it is possible to discharge the coating liquid at a high speed. More specifically, performing the discharge operation in a state in which the pressure wave due to the shaking operation remains after the shaking operation greatly affects the size of the pressure wave generated in the discharge operation. Since the pressure inside the nozzle at the start of the discharge operation varies when the waiting time is adjusted, the pressure wave generated by the discharge operation also varies, and the discharge amount of the droplet discharged from the nozzle can be varied.

The pressure wave imparting component can be a piezoelectric actuator, and a pressure wave can be generated in the coating liquid inside the nozzle by applying voltage to the piezoelectric actuator to change the volume within the nozzle.

With this coating device, a configuration that generates a pressure wave in the coating liquid inside the nozzle can be easily formed.

In view of the state of the known technology, a coating method is provided in which droplets of coating liquid are discharged from a nozzle to form a coating pattern on a substrate, in which the following steps are performed every time the coating liquid is discharged: a shaking step of generating a pressure wave in the coating liquid inside the nozzle to the extent that a droplet will not be discharged from the nozzle to shake the coating liquid inside the nozzle, and a discharge step of generating a pressure wave in the coating liquid inside the nozzle to the extent that a droplet will be discharged from the nozzle after the shaking step. The operation of generating a pressure wave in the coating liquid in the shaking step and the operation of generating a pressure wave in the coating liquid in the discharge step are each kept constant, and the waiting time, which is the time between the shaking operation and the discharge operation, is adjusted.

With this coating method, the discharge amount can be adjusted at each discharge, and it is possible to discharge the coating liquid at high speed. More specifically, after the shaking step, the discharge step is performed in a state in which the pressure wave resulting from the shaking step still remains, and this affects the size of the pressure wave generated in the discharge step. Since the pressure inside the nozzle changes at the start of the discharge step when the waiting time is adjusted, the pressure wave generated in the discharge step also changes, and the discharge amount of the droplet discharged from the nozzle can be varied.

With the coating device and the coating method of the present invention, the discharge amount can be adjusted at each discharge, and it is possible to discharge the coating liquid at high speed.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts unless otherwise stated.

While only selected embodiments have been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A coating device for coating a substrate with a coating liquid to form a coating pattern, the coating device comprising:
a nozzle configured to discharge droplets of the coating liquid;
a pressure wave imparting component configured to generate a pressure wave in the coating liquid inside the nozzle; and
a controller configured to control a drive of the pressure wave imparting component,
for each discharge of the coating liquid, the controller being configured to cause the pressure wave imparting component to perform
a shaking operation that is configured to generate a pressure wave in the coating liquid inside the nozzle to an extent that a droplet is not discharged from the nozzle and the coating liquid is shaken in the nozzle, and
a discharge operation that is configured to generate a pressure wave in the coating liquid inside the nozzle to an extent that a droplet is discharged from the nozzle after the shaking operation, and
the drive of the pressure wave imparting component in the shaking operation and the drive of the pressure wave imparting component in the discharge operation being kept constant, and a waiting time between the shaking operation and the discharge operation being adjusted.

2. The coating device according to claim 1, wherein
the pressure wave imparting component includes a piezoelectric actuator, and is configured to generate a pressure wave in the coating liquid inside the nozzle by applying voltage to the piezoelectric actuator to change volume within the nozzle.

3. The coating device according to claim 1, wherein
the controller is configured to control the drive of the pressure wave imparting component according to a shaking waveform during the shaking operation and according to a discharge waveform during the discharge operation, with the shaking waveform being different from the discharge waveform.

4. The coating device according to claim 3, wherein
the controller is configured to cause the pressure wave imparting component to reduce the volume of the nozzle for a specific length of time according to the shaking waveform during the shaking operation.

5. The coating device according to claim 4, wherein
the shaking waveform has a pulse with a predetermined voltage for the specific length of time.

6. The coating device according to claim 3, wherein
the controller is configured to cause the pressure wave imparting component to increase the volume of the nozzle before reducing the volume of the nozzle according to the discharge waveform during the discharge operation.

7. The coating device according to claim 6, wherein
the discharge waveform has a first pulse with a first predetermined voltage and a second pulse with a second predetermined voltage.

8. The coating device according to claim 7, wherein
the first predetermined voltage of the discharge waveform has an opposite polarity to the second predetermined voltage of the discharge waveform.

9. The coating device according to claim 7, wherein
the controller is configured to cause the pressure wave imparting component to increase the volume of the nozzle at a timing of the first pulse and to reduce the volume of the nozzle at a timing of the second pulse.

10. The coating device according to claim 1, wherein
the drive of the pressure wave imparting component in the shaking operation and the drive of the pressure wave imparting component in the discharge operation are kept constant for a plurality of discharges of the coating liquid.

11. The coating device according to claim 1, wherein
the waiting time between the shaking operation and the discharge operation is adjusted according to a discharge amount of a droplet of the coating liquid.

12. The coating device according to claim 11, wherein
the waiting time between the shaking operation and the discharge operation is adjusted for each discharge of the droplet of the coating liquid.

13. A coating method for forming a coating pattern on a substrate by discharging droplets of coating liquid from a nozzle, the coating method comprising:
performing a shaking operation for generating a pressure wave in the coating liquid inside the nozzle to an extent that a droplet is not be discharged from the nozzle and the coating liquid inside the nozzle is shaken; and
performing a discharge operation for generating a pressure wave in the coating liquid inside the nozzle to an extent that a droplet is discharged from the nozzle after the performing of the shaking operation,
the performing of the shaking operation and the performing of the discharge operation being performed for each discharge of the coating liquid, and
the shaking operation and the discharge operation being kept constant, and a waiting time between the shaking operation and the discharge operation being adjusted.
